(19) United States
(12) Patent Application Publication
(10) Pub. No.: US 2009/0243437 A1
(43) Pub. Date: Oct. 1, 2009

(54) MULTILAYERED ACTUATORS HAVING INTERDIGITAL ELECTRODES

(76) Inventors: Hans-Jurgen Schreiner, Neunkirchen am Sand-Rollhofen (DE); Jurgen Schmidt, Marktredwitz (DE); Reiner Bindig, Bindlach (DE)

Correspondence Address: FULBRIGHT & JAWORSKI, LLP, 666 FIFTH AVE, NEW YORK, NY, 10103-3198, US

(21) Appl. No.: 12/282,518

(22) PCT Filed: Mar. 15, 2007
(86) PCT No.: PCT/EP2007/052444

§ 371 Date: Dec. 12, 2008

(30) Foreign Application Priority Data
Mar. 16, 2006 (DE) 10 2006 012 588.6
Oct. 25, 2006 (DE) 10 2006 025 080.1

(51) Int. Cl. H02N 2/04

(52) U.S. Cl. 310/357

(57) ABSTRACT

The invention relates to a method for producing a monolithic multilayered actuator comprising a stack of thin active piezoceramic films with applied metallic inner electrodes which reciprocally lead from the stack and are electrically connected in parallel using outer electrodes.

The invention relates to a method for producing a monolithic multilayer actuator in accordance with the preamble of claim 1 and to a multilayer actuator in accordance with the preamble of claim 2.

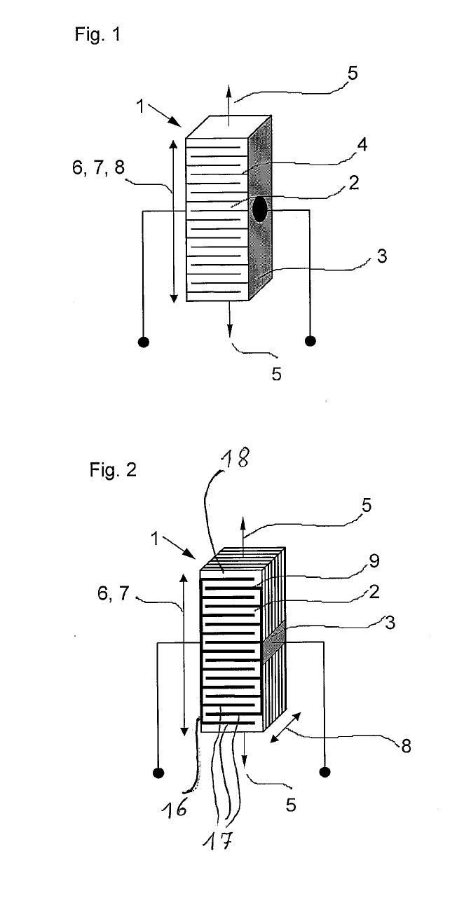

Monolithic multilayer actuators (also referred to generally as actuators in the following) in accordance with the prior art as a rule consist of stacked thin layers 2 of active material, for example a piezoceramic material or electrostrictive materials, having in each case conductive inner electrodes 4 arranged in between. Outer electrodes 3 connect these inner electrodes 4 alternately. As a result, the inner electrodes 4 are electrically connected in parallel and combined to form two groups that represent the two terminal poles of the actuator (see FIG. 1).

If an electric voltage is applied to the terminal poles, this is transmitted in parallel to all the inner electrodes and gives rise to an electric field in all the layers of active material which as a result is mechanically deformed. The sum of all these mechanical deformations is available at the end faces of the actuator as an operational d/or force in the direction of the longitudinal axis 5 of the actuator.

The effect which has been described is also referred to as a 33-effect, since the electric field is applied in the direction of polarization (direction in space: first index 3), and the mechanical effects that occur in the same direction (direction in space: second index 3) are used. In contrast with this, the 31- effect that is used in the case of many bending elements characterises the application of the electric field in the direction of polarization (direction in space first index 3) and the use of the mechanical effects at .right angles thereto (direction in spade second index 1).

In order to be able to use the 33-effect, the direction of polarization 6 and the direction of movement 7 of the actuator must run in the same direction, normally in the direction of the longitudinal axis 5 of the actuator. This means that, as shown in FIG. 1, the individual layers 2 and inner electrodes 4 lie at right angles to the longitudinal axis 5 of the actuator, and the layering direction 8 runs parallel to the longitudinal axis 5 of the actuator.

Very many layers or courses of ceramic material therefore need to be stacked one on top of the other with inner electrodes, with the inner electrodes being formed as thin metal layers. For an actuator having dimensions of 7×14×100 mm, 1100 courses, for example, with a respective thickness of 0.09 mm need to be stacked one on top of the other with accuracy of fit.

The underlying object of the invention is to improve a method for producing a multilayer actuator in accordance with the preamble of claim 1 in such a way that known and commercially customary technology can be used for the stacking and laminating machines. Moreover, a multilayer actuator in accordance with the preamble of claim 2 which given a very small base area can have a great height and which in particular has been produced in accordance with the method just mentioned is to be specified.

In accordance with the invention, this object is achieved with regard to the method by means of the features of claim 1.

By virtue of the fact that the inner electrodes of both polarities are applied as conductor strips to each active film, the layering direction 8 of all the active films are [sic] arranged at right angles to the longitudinal axis of the multilayer actuator, and the films are sintered together with the inner electrodes in a co-firing process, it is possible to use known and commercially customary technology for the stacking and laminating machines.

What is understood by co-firing process is that the inner electrodes are completely laminated in and sintered together with the ceramic material. The co-firing process is thus the simultaneous sintering of the inner electrodes together with the ceramic films in one working step.

In accordance with the invention, the object is achieved with regard to the multilayer actuator by means of the features of claim 2.

By virtue of the fact that the inner electrodes of both polarities are arranged as printed conductors or conductor strips on each active film, the layering direction of all the active films are [sic] arranged at right angles to the longitudinal axis of the multilayer actuator, and the films are sintered together with the inner electrodes in a co-firing process, in a simple way it is possible to make multilayer actuators (33-actuators) with a great height, which are required for valve drives, for example.

It is also very easily possible to manufacture 33-actuators with a very small base area and a great height, as required for 33-bending actuators.

It is also very easily possible to produce these bending elements directly in the same process moholithically.

The inner electrodes are no longer introduced into the actuators all over as a metal layer, but as conductor strips with conductors that are as fine as possible. Therefore only a fraction of the very expensive inner-electrode material that contains noble metal is required.

All in all, the method in accordance with the invention results in a more simple and less complicated process, in savings with regard to the inner electrode containing noble metal, and thus in considerably lower production costs for actuators and bending elements.

It is possible to make actuator types in an economical way which up until now for cost reasons could not be produced in large piece numbers. For an actuator having dimensions of 7×14×100 mm, in accordance with this method only 77 courses with a respective thickness of 0.1 mm need to be stacked one on top of the other with accuracy of fit.

A development of the invention is distinguished in that the inner electrodes of both polarities are formed in the manner of a comb with a respective base conductor and comb conductors, issuing from the latter substantially at right angles, with the comb conductors of both polarities interlocking in such a way that as far as the edge region of the films each comb conductor of one polarity is arranged between two comb conductors of the other polarity. These inner electrodes that interlock in the manner of a comb are also referred to as interdigital electrodes in the following.

The base conductors are preferably arranged adjacently to opposing sides of the film.

The thickness of the films advantageously amounts to 10 μm to 300 μm, preferably to 30 μm to 100 μm. In a development in accordance with the invention the width of the conductor strips of the inner electrodes amounts to 0.05 to 0.5 mm, preferably to 0.1 to 0.2 mm.

The distance between the conductor strips of the inner electrodes is selected so that given a desired operating voltage a field strength of 0.5 to 5 kV/mm, preferably 1.5 to 2.5 kV/mm, sets in.

In a development in accordance with the invention the multilayer actuator also contains in addition to the active films inactive films without inner electrodes so that one or more active zones and one or more inactive zones result and the multilayer actuator can bend during operation.

Films with an all-over inner electrode that is not electrically contacted by the outer electrode are preferably arranged between the active zones and the inactive zones.

A low-sintering piezoceramic material is preferably used for the ceramic material. Such a piezoceramic material is described, for example, in DE 198 40 488 A1.

The prior art and the invention will be explained in greater detail in the following with the aid of figures.

FIG. 1 shows a monolithic 33-actuator 1, constructed in accordance with the prior art.

It is to be emphasized that the polarization direction 6, the movement direction 7 and the layering direction 8 run in the direction of the longitudinal axis 5 of the actuator (see also the introduction to the description regarding this). All-over inner electrodes are used here.

Monolithic 33-actuators for bending elements cannot be produced in an expedient manner in accordance with the prior art by way of a stacking/laminating method, but are sawn off as thin discs from larger 33-actuators that have already been sintered and provided with electrodes.

33-bending actuators cannot be produced by stacking/laminating methods, but must be assembled, by bonding, from sintered partial actuators provided with electrodes.

FIG. 2 shows a monolithic 33-actuator (multilayer actuator) in accordance with the invention. It is to be emphasized that the polarization direction 6 and the movement direction 7 run in the direction of the longitudinal axis 5 of the actuator. The direction of the layering 8, on the other hand, runs at right angles thereto. The interdigital electrodes 9 are electrically connected at the side by outer electrodes 3. Only one of the outer electrodes 3 is shown; the other outer electrode is located on the opposite side.

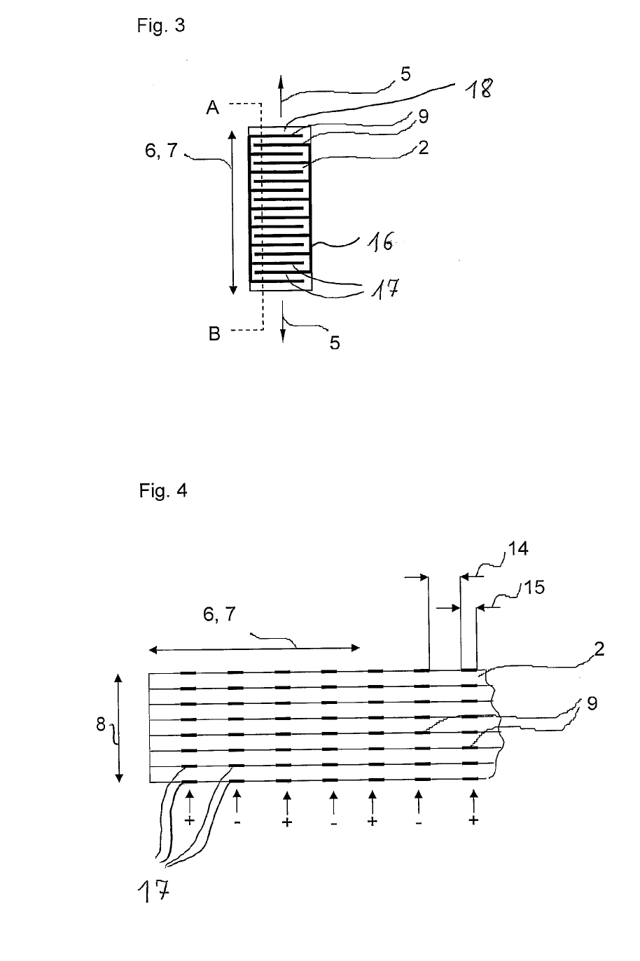

FIG. 3 shows a view of a monolithic 33-actuator in accordance with the invention with interlocking interdigital electrodes 9.

FIG. 4 shows a section through the monolithic 33- actuator that is shown in FIG. 3 along the line of intersection A-B. Attention is drawn to the alternating polarity of the interdigital electrodes 9 and the fact that the layering direction 8 is at right angles to the polarization direction 6 and movement direction 7.

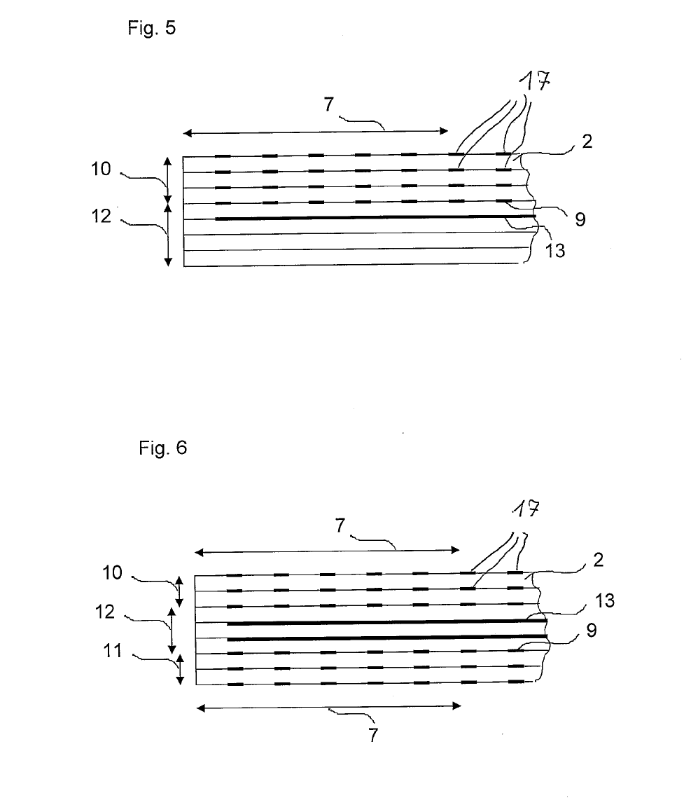

FIG. 5 shows a section (as in FIG. 4) through a monolithic 33-bending actuator, constructed according to the method in accordance with the invention. By leaving out the interdigital electrodes 9 in the lower layering region, an inactive zone 12 develops. The remaining actuator packet 10 or the active zone bends the structure downwards when it extends in the movement direction 7. Inner electrodes 13 that are applied all over and are not contacted electrically prevent cracks, which might develop as a result of the bending, from growing into the passive zone.

FIG. 6 shows a section through a monolithic 33-bending actuator, constructed according to the method in accordance with the invention. By leaving out the electrodes in the central layering region, an inactive zone 12 develops. The remaining actuator packets 10, 11 bend the structure upwards or downwards when they extend 7 alternately. Inner electrodes 13 that are applied all over and are not contacted electrically prevent cracks, which might develop as a result of the bending, from growing into the inactive zone 12.

1-10. (canceled)

11. A method comprising producing a monolithic multilayer actuator from a stack of thin active films made from piczoceramic material with applied metallic inner electrodes that reciprocally lead out from the stack and are electrically connected in parallel by way of outer electrodes, by applying the inner electrodes of both polarities as conductor strips to each active film, arranging the layering direction of all the active films at right angles to the longitudinal axis of the multilayer actuator, and sintering the films together with the inner electrodes in a co-firing process.

12. A monolithic multilayer actuator produced by the method of claim 11, wherein the inner electrodes of both polarities are arranged as conductor strips on each active film, the layering direction of all the active films is arranged at right angles to the longitudinal axis of the multilayer actuator, and the films are sintered together with the inner electrodes in a co-firing process.

13. A multilayer actuator according to claim 12, wherein the inner electrodes of both polarities are formed in the manner of a comb with a respective base conductor and comb conductors issuing from the latter substantially at right angles, with the comb conductors of both polarities interlocking in such a way that as far as the edge region of the films each comb conductor of one polarity is arranged between two comb conductors of the other polarity.

14. A multilayer actuator according to claim 12, wherein the base conductors are arranged adjacently to opposing sides of the film.

15. A multilayer actuator according to claim 12, wherein the films have a thickness of from 10 μm to 300 μm.

16. A multilayer actuator according to claim 12, wherein the conductor strips of the inner electrodes has a width of 0.05 to 0.5 mm.

17. A multilayer actuator according to claim 12, wherein there is a distance between the conductor strips of the inner electrodes that is selected so that given a desired operating voltage a field strength of 0.5 to 5 kV/mm sets in.

18. A multilayer actuator according to claim 12, wherein the multilayer actuator further comprises inactive films without inner electrodes so that one or more active zones and one or more inactive zones are provided and during operation the multilayer actuator can execute a bend.

19. A multilayer actuator according to claim 18, wherein films with an all-over inner electrode that is not electrically contacted by the outer electrode are arranged between the active zones and the inactive zones.

20. A multilayer actuator according to claim 12, wherein the piezoceramic material is a low-sintering piezoceramic material.
